(19) United States
(12) Patent Application Publication
(10) Pub. No.: US 2025/0061437 A1
(43) Pub. Date: Feb. 20, 2025

(54) SERVER AND METHOD FOR PROVIDING REVENUE DISTRIBUTION SERVICE IN CASE THERE IS A CURATOR WHO IS A THIRD PARTY USER FOR TRANSACTIONS ON AN NFT CONTENT PLATFORM

(71) Applicant: Jung Hun LEE, Seoul (KR)

(72) Inventor: Jung Hun LEE, Seoul (KR)

(21) Appl. No.: 18/807,078

(22) Filed: Aug. 16, 2024

(30) Foreign Application Priority Data
Aug. 17, 2023 (KR) 10-2023-0107475

(51) Int. Cl. G06Q 20/12; G06Q 30/0201

(52) U.S. Cl. CPC G06Q 20/123; G06Q 30/0201; G06Q 2220/00

(57) ABSTRACT

Disclosed is a system that provides an NFT-based content transaction platform for orders related to products and services and provides a service that provides a product list to a user's terminal when it is recognized that the user has approached or entered a store within a preset distance to allow the user to place an order on the terminal, a service for allowing a user to create and sell NFT content and providing appropriate rewards to a user who have sold NFT content according to an algorithm.

### CROSS-REFERENCE TO RELATED APPLICATIONS

This application claims the benefit of Korean Patent Application No. 10-2023-0107475, filed on Aug. 17, 2023, in the Korean Intellectual Property Office, the disclosure of which is incorporated herein in its entirety by reference.

### BACKGROUND

Embodiments of the present disclosure described herein relate to a server for providing a revenue distribution service when there is a curator who is a third-party user for transaction on an NFT content platform.

The number of people using stores such as cafes is increasing every year, and recently, the number of stores applying kiosk devices is increasing.

However, despite these changes, stores still have many people waiting in line to order, which causes crowding inside the stores and requires additional staff to take orders.

In this regard, it is expected that the above problem is alleviated by receiving orders using smart-phones that most people have, but this is not being properly applied, and there is a problem of under-utilization of a relevant application due to the inconvenience of users having to run the application separately each time they enter the store.

### SUMMARY

Embodiments of the present disclosure provide a server that provides an NFT-based content transaction platform.

In addition, embodiments of the present disclosure provide a service capable of providing a product list to a user's terminal to allow the user to place an order with the terminal when it is recognized that the user has approached or entered a store.

In addition, embodiments of the present disclosure provide a service that allows a user to place an order with the user's terminal using not only general fiat currency and credit/check cards, but also cryptocurrency.

In addition, embodiments of the present disclosure provide a service capable of allowing a user to create and sell NFT content, and providing a suitable reward to a user who has sold NFT content according to an algorithm.

However, problems to be solved by the inventive concept may not be limited to the above-described problems. Although not described herein, other problems to be solved by the inventive concept can be clearly understood by those skilled in the art from the following description.

According to an embodiment, a server includes a communication unit that communicates with a user terminal, a storage unit that stores an algorithm for distributing revenue based on sale of NFT content, at least one instruction, and content created by a user, and a processor that executes the at least one instruction, wherein the user includes a first user who creates the content, a second user who resells the content created by the first user to others, and a third user, wherein the third user is a user with curator rights to manage, register and maintain content posted on a platform's bulletin board, and Non-Fungible Token (NFT) minting is carried out and posted on the bulletin board when the content is sold by the second user, wherein the processor, when at least one content created by the first user is received from the first user terminal, allows the third user to perform curation of the received content, wherein the content posted on the bulletin board is able to be sold to other users using the platform by the second user, and wherein the processor, when purchase and sale activities for the content are performed, calculates revenue allocations of the first user, the second user, and the third user based on the algorithm for distributing revenue, calculates a first influence index based on a number of views for a post of specific content and a number of positive responses to the post of the specific content, and calculates revenues of the first user and the third user based on the calculated first influence index.

According to an embodiment, a method performed by a server includes receiving at least one content created by a first user from a first user terminal, allowing a third user to perform curation of the received content, wherein the third user is a user with curator rights to manage, register and maintain content posted on a platform's bulletin board, wherein Non-Fungible Token (NFT) Minting is carried out and posted on the bulletin board when the content is sold by a second user, wherein the content posted on the bulletin board is able to be sold to other users using the platform by the second user, wherein the server, when purchase and sale activities for the content are performed, calculates revenue allocations of the first user, the second user, and the third user based on the algorithm for distributing revenue, calculates a first influence index based on a number of views for a post of specific content and a number of positive responses to the post of the specific content, and calculates revenues of the first user and the third user based on the calculated first influence index.

In addition, a computer program stored in a computer-readable recording medium, for executing a method to implement the present disclosure may be further provided.

In addition, a computer-readable recording medium for recording a computer program for executing a method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram of a system for providing an NFT-based content transaction platform according to an embodiment of the present disclosure;

FIG. 2 is a block diagram of a system for providing an NFT-based content transaction platform according to an embodiment of the present disclosure;

FIG. 3 is a flowchart of a method of providing an NFT-based content transaction platform according to an embodiment of the present disclosure;

FIG. 4 shows an example in which a sensor unit installed in a store recognizes that a user terminal has entered a store;

FIG. 5 is a diagram showing an example of information displayed on the screen of the user terminal when a service application is executed;

FIG. 6 is a diagram showing an example of the addition of a fourth area and a fifth area in FIG. 5;

FIG. 7 is a diagram showing order information;

FIG. 8 is a drawing illustrating a process within the system, which is performed according to payment using a cryptocurrency payment method;

FIG. 9 is a diagram showing an example in which NFT content created by a user is uploaded to the server; and

FIG. 10 is a drawing illustrating revenue provided according to the sale of NFT content.

### DETAILED DESCRIPTION

Like reference numerals refer to like elements throughout the present disclosure. The present disclosure does not describe all elements of the embodiments, and general content in the technical field to which the present disclosure pertains or overlapping content between embodiments are omitted. Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected to” another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the specification, a certain member being located “on” another member includes not only a case where the certain member is in contact with another member, but also a case where another member exists between two members.

Terms such as first and second are used to distinguish one component from another component, and the components are not limited by the above-mentioned terms.

As used herein, singular forms may include plural forms as well unless the context clearly indicates otherwise.

In each step, identification symbols are used for convenience of description and the identification symbols do not describe the order of the steps and the steps may be performed in a different order from the described order unless the context clearly indicates a specific order.

Hereinafter, the operating principle and embodiments of the present disclosure will be described with reference to the attached drawings.

In this specification, a ‘server for providing an NFT-based content transaction platform according to the present disclosure’ includes various devices capable of performing computational processing and provides results to users. For example, the server for providing the NFT-based content transaction platform according to the present disclosure may include all of a computer, a server device, and a portable terminal, or may be in the form of any one thereof.

Here, the computer may include, for example, a notebook, a desktop, a laptop, a tablet PC, a slate PC, or the like, which is equipped with a web browser.

The server device is a server that processes information by communicating with an external device, and may include an application server, a computing server, a database server, a file server, a game server, a mail server, a proxy server, a web server and/or the like.

The portable terminal may be, for example, a wireless communication device that is portable and mobile and may include all types of handheld-type wireless communication devices, such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), or WiBro (Wireless Broadband Internet) terminals, and wearable devices such as watches, rings, bracelets, anklets, necklaces, glasses, contact lenses, or head-mounted-device (HMD), or the like.

Functions related to artificial intelligence according to the present disclosure are performed through a processor and a storage unit. The processor may include one or a plurality of processors. The one or more processors may be a general-purpose processor such as a CPU, AP, DSP (Digital Signal Processor), a graphics processor such as a GPU or VPU (Vision Processing Unit), or an AI processor such as an NPU. The one or more processors are controlled to process input data according to a predefined behavioral rule or artificial intelligence model stored in the storage unit. Alternatively, when the one or more processors are dedicated AI processors, the AI processors may be designed as a hardware architecture that is specialized for processing a specific AI model.

The predefined behavioral rule or AI model is characterized by being generated through learning. As used herein, being generated through learning means that an underlying AI model is trained by a learning algorithm using a plurality of training data, resulting in a predefined behavioral rule or AI model that is set to perform a desired characteristic (or, purpose). This training may be made on the device itself, where the artificial intelligence according to the present disclosure is performed, or through a separate server and/or system. Examples of learning algorithms include, but are not limited to, supervised learning, unsupervised learning, semi-supervised learning, or reinforcement learning.

The artificial intelligence model may include a plurality of neural network layers. Each of the plurality of neural network layers has a plurality of weights, and performs a neural network operation by performing computation between the computation results of the previous layers and the plurality of weights. The plurality of weights of the plurality of neural network layers may be optimized by the learning results of the AI model. For example, during the learning process, the plurality of weights may be updated such that the loss value or cost value obtained by the AI model is reduced or minimized. The artificial neural network may include a deep neural network (DNN), and may be, but not limited to, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network.

According to example embodiments of the present disclosure, the processor may implement artificial intelligence. Artificial intelligence refers to machine learning methods based on artificial neural networks that allow machines to learn by imitating biological neurons. The methodology of artificial intelligence may be categorized into supervised learning, in which the answer to a question (input data) is determined by providing both input and output data as training data, unsupervised learning, in which the answer to a question (input data) is not determined because only input data is provided without output data, and reinforcement learning, in which rewards are given by an external environment whenever a certain action is taken in a current state, and learning proceeds in the direction of maximizing these rewards. The methodologies of artificial intelligence may also be categorized by architecture, which is the structure of the learning model, and the architectures of popular deep learning techniques include convolutional neural networks, recurrent neural networks, transformers, and generative adversarial neural networks.

The present device may include an artificial intelligence model. The artificial intelligence model may be a single artificial intelligence model or may be implemented with a plurality of artificial intelligence models. The artificial intelligence model may be composed of a neural network (or artificial neural network), which may include a statistical learning algorithm that mimics a biological neuron in machine learning and cognitive science. A neural network may generally refer to a model having problem-solving ability in such a way that artificial neurons (nodes) constituting a network with synaptic bonding change the strength of synaptic bonding through learning. The neurons in a neural network may include any combination of weights or biases. The neural network may include one or more layers each composed of one or more neurons or nodes. For example, a device may include an input layer, a hidden layer, and an output layer. The neural network constituting the device may infer a desired outcome to be predicted from arbitrary inputs by varying the weights of the neurons through learning.

A processor may generate a neural network, train (or learn) the neural network, perform operations based on received input data, generate information signals based on the results of the operations, or retrain the neural network. The models of the neural network may include various types of models such as CNN, R-CNN, RPN, RNN, S-DNN, S-SDNN, Deconvolution Network, DBN, RBM, Fully Convolutional Network, LSTM Network, Classification Network, etc., such as GoogleNet, AlexNet, VGG Network, but are not limited thereto. The processor may include one or more processors for performing operations according to the models of the neural network. For example, the neural network may include a deep neural network.

It will be understood by those skilled in the art that the neural network may include a CNN, an RNN, a perceptron, a multilayer perceptron, a FF (Feed Forward), an RBF (Radial Basis Network), a DFF (Deep Feed Forward), an LSTM (Long Short Term Memory), a GRU (Gated Recurrent Unit), an AE (Auto the neural network may include any neural network, including but not limited to Encoder (VAE), Variational Auto Encoder (VAE), Denoising Auto Encoder (DAE), Sparse Auto Encoder (SAE), Markov Chain (MC), Hopfield Network (HN), Boltzmann Machine (BM), Restricted Boltzmann Machine (RBM), Depp Belief Network (DBN), Deep Convolutional Network (DCN), Deconvolutional Network (DN), Deep Convolutional Inverse Graphics Network (DCIGN), Generative Adversarial Network (GAN), Liquid State Machine (LSM), Extreme Learning Machine (ELM), Echo State Network (ESN), Deep Residual Network (DRN), Differentiable Neural Computer (DNC), Neural Turning Machine (NTM), Capsule Network (CN), Kohonen Network (KN), and Attention Network (AN), but is not limited thereto.

According to an example embodiment of the present disclosure, the processor may include a Convolution Neural Network (CNN), Region with Convolution Neural Network (R-CNN), Region Proposal Network (RPN), Recurrent Neural Network (RNN), Stacking-based deep Neural Network (S-DNN), State-Space Dynamic Neural Network (S-SDNN), Deconvolution Network, Deep Belief Network (RBM), such as GoogleNet, AlexNet, VGG Network, etc. CTed Boltzman Machine), Fully Convolutional Network, LSTM (Long Short-Term Memory) Network, Classification Network, Generative Modeling, e Time-Series Forecasting, Various artificial intelligence structures and algorithms such as Optimization, Recommendation, and Data Creation can be used, but are not limited thereto. Hereinafter, an embodiment of the present disclosure will be described in detail with reference to the attached drawings.

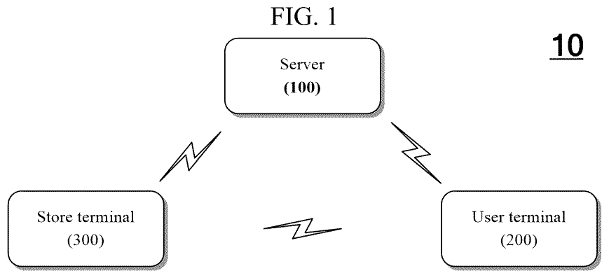

FIG. 1 is a schematic diagram of a system 10 for providing an NFT-based content transaction platform according to an embodiment of the present disclosure.

Referring to FIG. 1, the system 10 for providing an NFT-based content transaction platform may include a server 100, a user terminal 200, and a store terminal 300.

However, in some embodiments, the system 10 may include fewer components or more components than the components shown in FIG. 1.

In an embodiment of the present disclosure, the server 100 may communicate with the store terminal 300 and the user terminal 200, and when the user terminal 200 has entered a store within a certain distance or it is identified that the user terminal 200 has entered the store, the server 100 may provide the user terminal 200 with a list of products sold in the store, and receive order information for a specific product from the user terminal 200.

In the embodiment of the present disclosure, the terminal 200 of an operator who operates the store, or a separate device for operating the store may be applied as the store terminal 300. In addition, at least one sensor for recognizing a terminal 200 approaching the store or a terminal 200 entering the store may be installed at least one location inside and outside the store to recognize that the terminal 200 approaches the store within a preset distance or enters a store entrance, and transmit information about the terminal 200 to the server 100 to allow the server 100 to recognize the user who is the owner of the terminal 200.

As described above, a sensor unit 340 in the system 10 may include a first sensor installed inside the store to detect a terminal 200 entering the store, and a second sensor installed outside the store to detect a terminal 200 approaching the store within the preset distance.

In some embodiments, the sensor unit 340 includes at least one sensor installed at or near a store entrance, and may detect the terminal 200 within the preset distance from the store entrance through the sensor, and a processor 110 or 310 may distinguish between a terminal 200 within the store and a terminal 200 approaching the store within the preset distance based on data sensed through the sensor unit 340.

In addition, the server 100 may receive NFT content created by a user, post the NFT content on a platform or SNS operated by the server 100, and provide a function for allowing other users to resell or purchase the NFT content.

The process of the method for providing an NFT-based content transaction platform in the server 100 according to an embodiment of the present disclosure will be briefly described as follows: 1. When it is identified that a customer has approached the store within a preset distance or entered the store, the app of the corresponding store is automatically executed as an app on the customer's terminal 200. 2. A screen for ordering products of the corresponding store is displayed on the lock screen of the terminal 200. 3. When a customer checks the list of products on an order screen and selects a specific product, the selection information is summarized and displayed at the bottom of the order screen, and selection and payment are made by swiping left/right/up/down. 4.1 Customers who have completed payment may create NFT content on the platform and proceed with NFT minting. 5. The platform provides a certain value of cryptocurrency to the customer in return for creating NFT content. 6. The created NFT content is posted on the bulletin board of the platform and may be purchased or resold by other users through cryptocurrency payment. 4.2 The payment amount is displayed along with the customer's order list on the screen of the store owner's terminal 200, and the store owner may receive the payment amount according to the currency setting option he or she wishes to receive.

With reference to other drawings, the provision of the NFT-based content transaction platform on the server 100 is described in more detail.

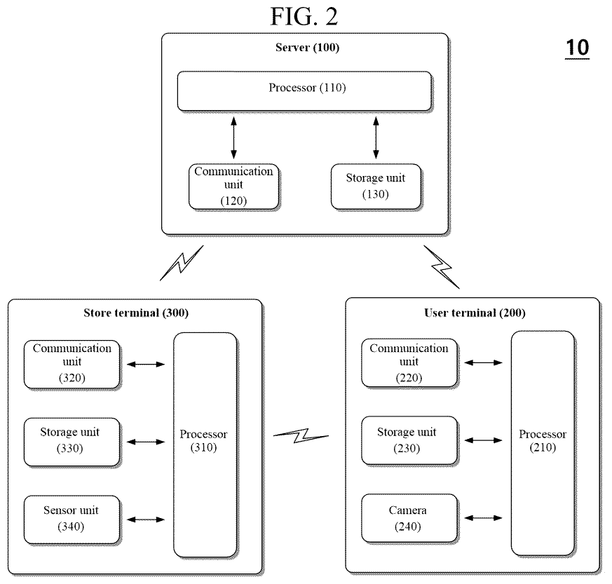

FIG. 2 is a block diagram of the system 10 for providing an NFT-based content transaction platform according to an embodiment of the present disclosure.

Referring to FIG. 2, the server 100 may include the processor 110, a communication unit 120, and a storage unit 130. The user terminal 200 may include a processor 210, a communication unit 220, a storage unit 230, and a camera 240. The store terminal 300 may include the processor 310, a communication unit 320, a storage unit 330, and the sensor unit 340.

In some embodiments, the server 100 may include fewer or more components than the components illustrated in FIG. 2.

The processor 110, 210, or 310 may be implemented with the storage unit 130, 230, or 330 that stores data about an algorithm or a program that stores an algorithm for controlling the operations of components within at least one device among the server 100, the user terminal 200, and the store terminal 300, and data on a program that reproduces the algorithm and at least one processor 110, 210, or 310 that performs the aforementioned operation using the data stored in the storage unit 130, 230, or 330. In this case, the storage unit 130, 230, or 330 and the processor 110, 210, or 310 may be implemented as separate chips. Alternatively, the storage unit 130, 230, or 330 and the processor 110, 210, or 310 may be implemented as a single chip.

In addition, the processor 110, 210, or 310 may control one or more the aforementioned components in combination to implement various embodiments according to the present disclosure to be described below with reference to the drawings on the corresponding device.

The processor 110, 210, or 310 may generally control the overall operation of the corresponding device as well as the operation related to the application program. The processor 110, 210 or 310 may provide or process information or a function appropriate to a user by processing signals, data, information, and the like, which are input or output through the above-described components, or by executing an application program stored in the storage unit 130, 230, or 330.

In addition, the processor 110, 210, or 310 may control at least some of the components of a corresponding device to execute an application program stored in the storage unit 130, 230, or 330 In addition, the processor 110, 210, or 310 may operate at least two or more of the components included in the corresponding device in a combination thereof to execute the application program.

The communication unit 120, 220, or 320 may include one or more modules that connect the server 100 providing the NFT-based content transaction platform to one or more networks.

The communication unit 120, 220, or 320 may include one or more components that enable communication with external devices, and may include at least one of, for example, a broadcast reception module, a wired communication module, a wireless communication module, a short-range communication module, and a location information module.

The wired communication module may include a variety of wired communication modules, such as a local area network (LAN) module, a wide area network (WAN) module, or a value added network (VAN) module, as well as a variety of cable communication modules, such as a universal serial bus (USB), high definition multimedia interface (HDMI), digital visual interface (DVI), recommended standard 232 (RS-232), power line communication, or plain old telephone service (POTS).

The wireless communication device may include not only a WiFi module and a wireless broadband module, but also wireless communication modules supporting various wireless communication schemes such as global system for mobile communication (GSM), code division multiple access (CDMA), wideband code division multiple access (WCDMA), universal system mobile telecommunications system (UMTS), time division multiple access (TDMA), long term evolution (LTE), 4G, 5G, and 6G.

The wireless communication module may include a wireless communication interface including an antenna and a transmitter for transmitting communication signals. The wireless communication module may further include a signal conversion module that modulates a digital control signal output from the processor 110, 210, or 310 into an analog radio signal via the wireless communication interface, under the control of the processor 110, 210, or 310.

The short-range communication module may support short-range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi Direct, and Wireless USB (Wireless Universal Serial Bus) technologies.

The storage unit 130, 230, or 330 may store data supporting various functions of the server 100, the user terminal 200, and the store terminal 300. The storage unit 130, 230, or 330 may store a number of application (or application programs) running on the server 100, the user terminal 200 or the store terminal 300, data and instructions for the operation of the corresponding device. At least some of the applications may be present for basic functionality of the corresponding device. The applications may be stored in the storage unit, installed on the device and operated by the processor 110, 210, or 310 to perform operations (or functions).

The storage unit 130, 230, or 330 may store data supporting various functions of the server 100, the user terminal 200, or the store terminal 300, programs for operation of the processor 110, 210, or 310, input/output data (e.g., music files, still images, moving images, or the like), and a number of applications (or application programs) running on the device, and data and instructions for operation of the corresponding device. At least some of the applications may be downloaded from an external server 100 via wireless communication.

The storage unit 130, 230, or 330 may include at least one type of storage medium among a flash memory type, a hard disk type, a solid state disk type, an Silicon Disk Drive type (SDD) type, a multimedia card micro type, a card type memory (e.g., SD or XD memory), random access memory (RAM), static random access memory (SRAM), read-only memory (ROM), electrically erasable programmable read-only memory (EEPROM) programmable read-only memory (PROM), magnetic memory, magnetic disk, and optical disk. Further, the storage unit may be a database that is separate from the host device but connected thereto in a wired or wireless manner.

Further, the storage unit 130, 230, or 330 may include a plurality of processes for the server 100 providing the NFT-based content transaction platform.

In an embodiment of the present disclosure, the user terminal 200 or the store terminal 300 may be any device including a processor, an input device (e.g., a touch screen), an output device (e.g., a touch screen), and a communication device, such as a smartphone, a tablet PC, or a notebook PC.

The user terminal 200 may further include a camera, and may generate NFT content using images taken through the camera.

The store terminal 300 may include the sensor unit 340 including at least one sensor, or may be connected to a separate sensor unit 340 via a communication unit. In this case, the sensor unit 340 may include a sensor installed in at least one location inside and outside a store.

Specifically, the sensor unit 340 may include a first sensor installed inside the store to detect the terminal 200 entering the store, and a second sensor installed outside the store to detect the terminal 200 approaching the store within the preset distance.

The sensor unit 340 may detect the terminal 200 that is determined to have approached the store within a preset distance or entered the store, and transmit the information about the detected terminal 200 to the server 100 to allow the server 100 to identify the owner (user) of the terminal 200.

In some embodiments, the store terminal 300 may allow a service application to be executed on the user terminal 200 by transmitting a service application execution signal to the terminal 200 that is determined, via the sensor unit 340, to have approached the store within a preset distance or entered the store.

In this case, the processor 110 or 310 may set a range of the preset distance. For example, the processor 110 or 310 may recognize, as a terminal that is close to the store, a terminal approaching within 10 m from the store or a terminal within 20 m from the store, based on the setting value received from the store terminal 300. In an embodiment, the processor 110 or 310 may set a terminal recognition distance by controlling the intensity/strength of a signal which the sensor of the sensor unit 340 transmits for terminal recognition/identification based on a proximity distance setting value.

The sensor unit 340 may detect at least one of information within a corresponding device, information about the surrounding environment of the corresponding device, and user information, and generate a corresponding sensing signal. Based on the sensing signal, the processor 110, 210, or 310 may control the operation or behavior of the corresponding device, or perform data processing, functions, or operations related to applications installed on the corresponding device.

For example, the sensor unit 340 may include at least one of a proximity sensor, an illumination sensor, a touch sensor, an acceleration sensor, a magnetic sensor, a G-sensor, a gyroscope sensor, a motion sensor, an RGB sensor, an infrared sensor (IR sensor), a finger scan sensor, an ultrasonic sensor, an optical sensors (e.g., camera), a microphone, an environmental sensor (e.g., including at least one of a barometer, a hygrometer, a thermometer, a radiation sensor, a thermal sensor, a gas sensor, or the like) and a chemical sensor (e.g., a healthcare sensor, a biometric sensor, or the like). The corresponding device may utilize pieces of information sensed by at least two or more of these sensors by combining the pieces of information.

The camera may process image frames such as still images or moving images obtained by an image sensor in a photographing mode. The processed image frame may be displayed on a display unit or stored in the storage unit.

The sensor unit 340 may sense/identify the user terminal 200 to determine that a user has approached the store or entered the store, which is to be described below.

The server 100 may provide a service application for providing a service, and when the service application is installed on the user terminal 200, the server 100 may request that a microphone function be turned on.

The sensor unit 340 may include an ultrasonic terminal 200 capable of outputting a high frequency signal.

In the following embodiment, all operations of the processor may be performed by the processor 110 of the server 100, or by the processor 310 of the store terminal 300.

The processor 110 or 310 may control the sensor unit 340 to output a high frequency signal at predetermined time periods, and identify a terminal 200 in the store through the high frequency signal.

Through this, the processor 110 or 310 may also identify a terminal 200 that have turned off a Bluetooth function.

For example, the processors 110 or 310 may identify the terminal 200 near or within the store using the Bluetooth module of the sensor unit 340.

The processors 110 or 310 may manage a list of in-store terminals 200 that are approaching the store within a preset distance or are present in the store, and when terminals 200 that are not in the list is detected, include the terminals 200 in the list of in-store terminals 200, determine that the terminal 200 belongs to a user who has newly entered the store, and output a control signal to execute a service application installed on the terminal 200.

The processor 210 of the user terminal 200 may, upon receiving the control signal, execute a service application installed on the terminal 200 to allow the user to order a menu/item.

In this case, the service application may allow the user to place an order even when the terminal 200 is activated on a lock screen and the user has not unlocked the terminal 200.

In some embodiments, the service application is executed and an order is placed while the terminal 200 is in the locked screen state as described above and, when order information is generated to make a payment, request that the terminal 200 be unlocked, thereby preventing payment from being made with malicious intent.

The processor 110 or 310 may identify the in-store terminal 200 in the store at preset time intervals via the sensor unit 340, and determine that a terminal 200, which has not been identified during a predetermined time period, has left the store among the terminals 200 in the list of in-store terminals 200.

The server 100 may receive the list of in-store terminals 200 from the store terminal 300 and determine a time period for which each terminal 200 has spent in the store, and statistical data may be generated with respect to the time period for which each terminal 200 has spent in the store as well as order information of customers using the store.

In an embodiment, the processor 210 of the user terminal 200 may identify the location of a first user terminal 200 at preset time intervals and determine that the first user terminal 200 has entered the first store when it is determined that the first user terminal 200 has entered a specified area or within a preset distance range from the first store.

In an embodiment, the sensor unit 340 may further include a camera that captures the entrance to the store, and the processor 110 or 310 may perform a process for identifying the presence of a new terminal 200 in the store when it is determined that a person is entering the store from the camera's image.

In an embodiment, when the processor 110 or 310 determines that the first user has entered the store and the new terminal 200 is present in the store by performing the process as described above, but nothing is detected in the captured image from the camera, the processor 110 or 310 may determine that an error has occurred in identifying the new terminal 200.

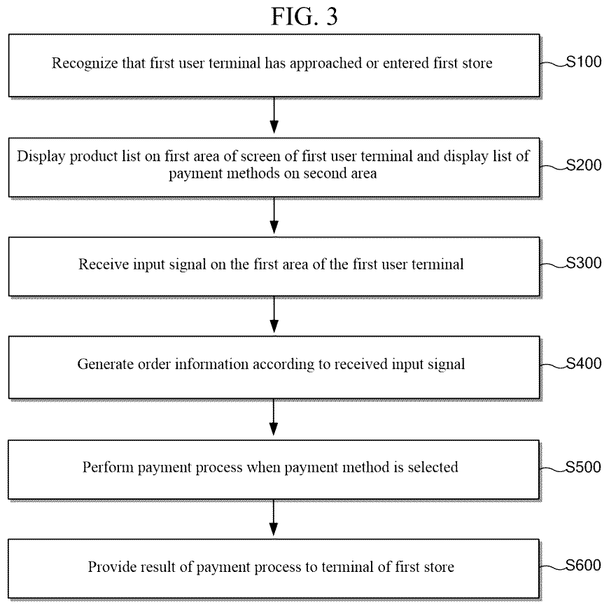

FIG. 3 is a flowchart of a method of providing an NFT-based content transaction platform according to an embodiment of the present disclosure.

The processor 110 or 310 may recognize that the first user terminal 200 has approached within a preset distance from a first store or has entered the first store based on the sensing value of the sensor unit 340 (S100).

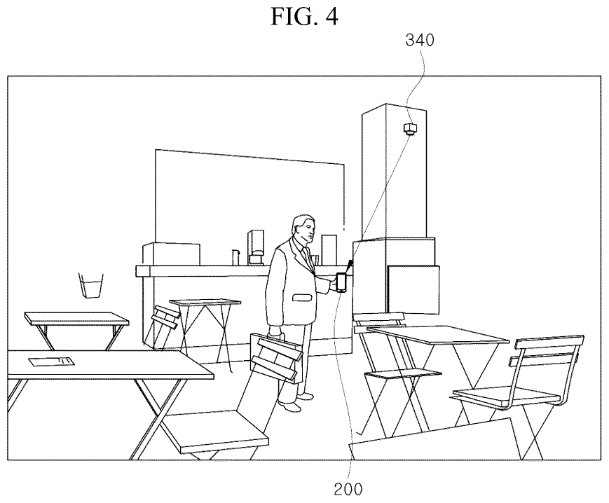

FIG. 4 shows an example in which the sensor unit 340 installed in a store recognizes that the user terminal 200 has entered a store.

As described above, the processor 110 or 310 may manage a list of terminals 200 identified as being present in each store (a list of in-store terminals 200), and when a first user terminal 200 that is not on the list of in-store terminals 200 is identified, as shown in FIG. 4, determine that the first user has entered the first store.

However, orders may not necessarily be placed only from user terminals 200 which have newly entered the store, and users may also place orders by directly executing the service application.

In addition, the processor 110 or 310 may update the list of in-store terminals 200 at preset time intervals based on the sensing data of the sensor unit 340. In addition, the processor 110 or 310 may determine that the user terminal 200 that is not recognized for more than a first time period has left the store, and that the user terminal 200 that is not recognized for a certain time period but is recognized again within a second time period that is shorter than the first time period has re-entered the store after other business, and may not execute the service application.

The processor 110 or 310 may display a list of products capable of being ordered from the first store on a first area of the screen of the first user terminal 200, and display a list of payment methods on a second area (S200).

The processor 110 or 310 may receive an input signal input on the first area of the first user terminal 200 (S300).

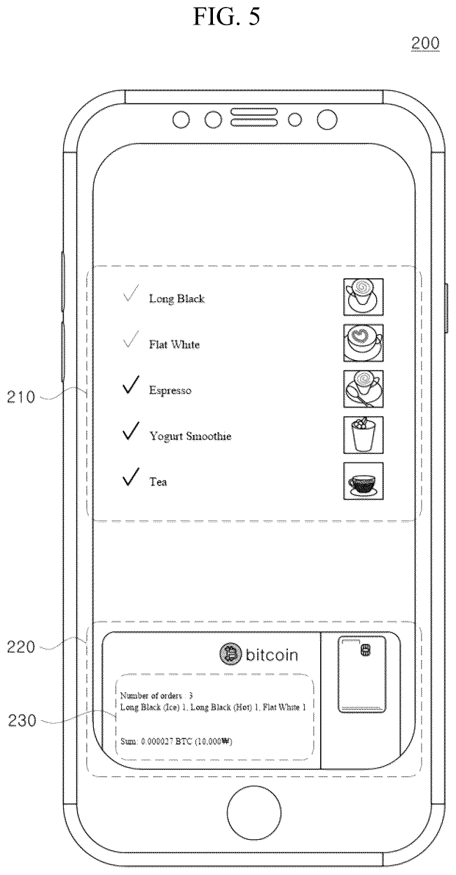

FIG. 5 is a diagram showing an example of information displayed on the screen of the user terminal 200 when a service application is executed.

The processor 110 or 310 may display a product list including at least one product capable of being ordered from the first store on the first area of the screen of the first user terminal 200.

The processor 110 or 310 may display a list of payment methods on the second area of the screen of the first user terminal 200.

In this case, the payment method may include a cryptocurrency payment method, a fiat currency payment method, a card payment method (e.g., a credit card or a check card), and the like.

The processor 110 or 310 may select a product, select a quantity of a product, or select an option of a product according to the input signal input on the first area.

The processor 110 or 310 may provide an input signal customization function to the user terminal 200. The user may customize the input signal on the first area through the function.

When a scroll signal by touch input is input on the first area of the first user terminal 200, the processor 110 or 310 may move the product list upward or downward to provide more product information.

For example, when an upper scroll signal or a lower scroll signal is input by touch input on the first area of the first user terminal 200, the processor 110 or 310 may move the screen of the product list upward or downward to provide information on more products.

As another example, when a left scroll signal or a right scroll signal is input by touch input on the first area of the first user terminal 200, the processor 110 or 310 may perform control such that a product list of a different category from the currently displayed product list is displayed.

As an example, when a specific product is double-clicked on the first area, the processor 110 or 310 may make a payment for the product or add the specific product to a shopping cart. When the specific product is 3D-touched on the first area, the processor 110 or 310 may make a payment for the product or add the specific product to the shopping cart.

The processor 110 or 310 may generate order information according to the input signal received in S300 (S400).

When the processor 110 or 310 selects a payment method for payment of order information, it proceeds with the payment process through the selected payment method. (S500)

The processor 110 or 310 may generate order information according to an input signal input on the first area of the first user terminal 200, and the order information includes the type and quantity of products that the first user wishes to purchase.

Referring to FIG. 5, it is shown that the first user has selected one long black (ICE), one long black (HOT), and one flat white on the first area of the terminal 200, and the processor 110 or 310 has generated order information based on the input signal received according to the selection and has displayed the order information on a third area.

Referring to FIG. 5, Bitcoin is selected as a payment method on the third area, and an image of a credit card is displayed on the right side of the third area. The user may select a payment method on the right side of the third area.

The processor 110 or 310 may provide the result of the payment process to the terminal 300 of the first store (S600).

When the payment process fails, the processor 110 or 310 may display the reason for the failure on the screen of the first user terminal 200.

When the payment is successful as a result of the payment process, the processor 110 or 310 may request the preparation of the product ordered by the first user by providing order information to the terminal 300 of the first store.

In an embodiment of the present disclosure, the server 100 may perform a refund process for the order upon the first user's request for a refund or order cancellation.

When a refund request is received from the first user terminal 200 after the payment is completed using a cryptocurrency payment method at the first user terminal 200, the processor 110 or 310 may refund the cryptocurrency paid at the time of sale of a corresponding product.

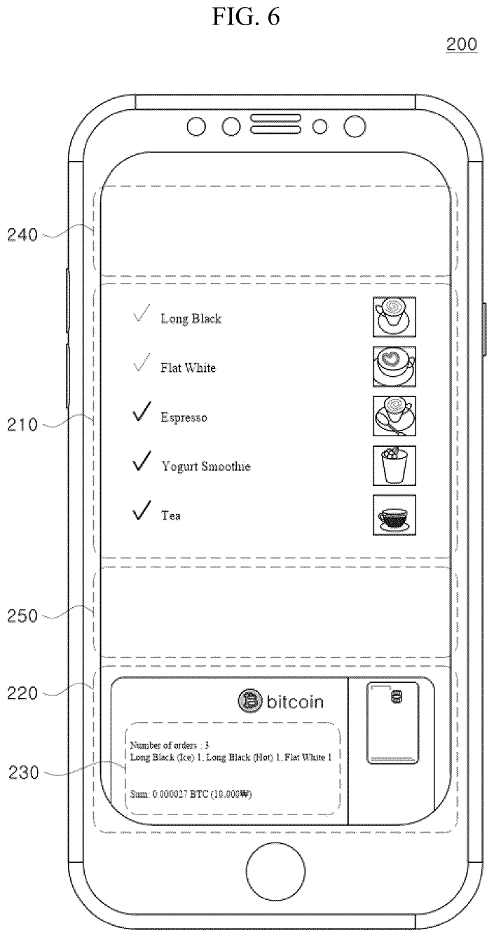

FIG. 6 is a diagram showing an example of the addition of a fourth area and a fifth area in FIG. 5.

The processor 110 or 310 may display information about the number of people waiting and the waiting time for the order of the first user on the fourth area.

The processor 110 or 310 may provide a shopping cart function for ordering products in the fifth area.

The processor 110 or 310 may add a product selected by an input signal input on the first area to the fifth area.

The processor 110 or 310 may add a product selected from the product list displayed on the first area and dragged to the fifth area to the shopping cart.

The processor 110 or 310 may generate order information based on the product included in the shopping cart in the fifth area.

When the preparation of the product ordered by the first user is completed, the processor 110 or 310 may display a preparation completion message in the fifth area.

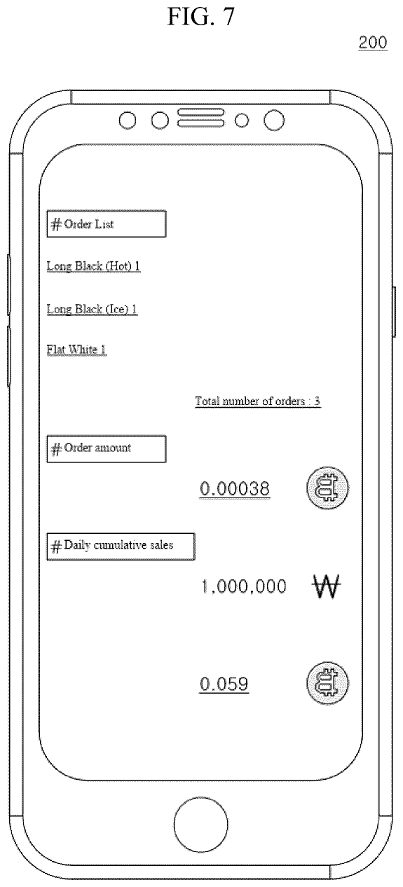

FIG. 7 is a diagram showing order information.

When an order is completed, the processor 110 or 310 may generate order information as shown in FIG. 7 and provide the generated order information to at least one of the first user terminal 200 and the first store terminal 300.

Referring to FIG. 7, the order information may include information about products paid and quantity, payment method, and payment amount.

In addition, the processor 110 or 310 may provide a daily cumulative sales amount to the store terminal 300.

In this case, the currency in which the first user makes a payment and the currency desired by the owner or manager of the first store may be different, and the server 100 may resolve the above-described issue through the following process.

When the first user makes a payment with cryptocurrency and the first store wants to receive cryptocurrency, the processor 110 may transfer cryptocurrency corresponding to the order information from the first user's electronic wallet to the first electronic wallet of the platform, and transfer the cryptocurrency corresponding to the order information from the first electronic wallet to the second electronic wallet of the first store.

When the first user makes a payment with fiat currency and the first store wants to receive fiat currency, the processor 110 may transfer fiat currency in an amount corresponding to the order information to the account of the first store.

When the first user makes a payment with cryptocurrency and the first store wants to receive fiat currency, the processor 110 may transfer cryptocurrency in an amount corresponding to the order information from the first electronic wallet of the first user to the second electronic wallet of the platform, and transfer fiat currency in an amount corresponding to the order information to the account of the first store, considering the value of the cryptocurrency and an exchange rate.

In the embodiment of the present disclosure, various cryptocurrencies such as Bitcoin Lightning Network, Ethereum, and Polygon may be applied as the cryptocurrency.

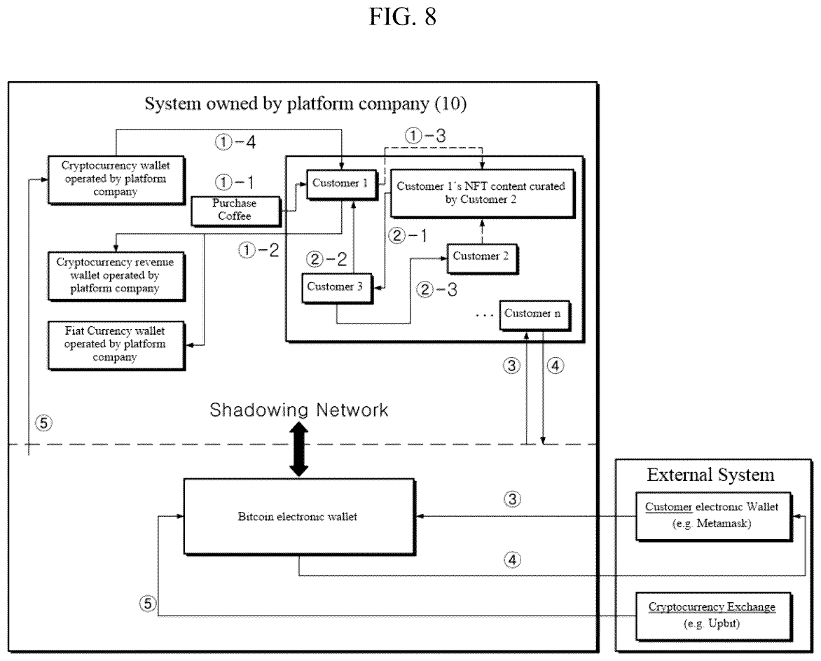

FIG. 8 is a drawing illustrating a process within the system 10, which is performed according to payment using a cryptocurrency payment method.

Referring to FIG. 8, a method of paying and utilizing cryptocurrency in the system 10 that provides an NFT-based content transaction platform according to an embodiment of the present disclosure will be described.

In an embodiment of the present disclosure, a customer's electronic wallet, which is not separately referred to as an external electronic wallet, may refer to an electronic wallet provided by a platform itself.

\textcircled{1} When customer “1” purchases a product (\textcircled{1}-1) with cryptocurrency or fiat currency (\textcircled{1}-2) and then provides NFT content (\textcircled{1}-3), the processor 110 may pay preset cryptocurrency from the second electronic wallet of the platform to the electronic wallet of customer “1” (\textcircled{1}-4).

\textcircled{2} When customer “3” purchases a product or NFT content with cryptocurrency owned by customer “3” (\textcircled{2}-1), the processor 110 may deduct the cryptocurrency in the electronic wallet of the customer, and the deducted cryptocurrency is paid as profit to the electronic wallets of customer “1” (content provider, \textcircled{2}-2) and customer “2” (content curator, \textcircled{2}-3).

\textcircled{3} When customer “n” remits external cryptocurrency (e.g., Bitcoin) to the platform, the processor 110 may remit the cryptocurrency from the external electronic wallet requested for remittance to the second electronic wallet of the platform, and remits the corresponding cryptocurrency to the customer's electronic wallet and provides it.

\textcircled{4} When customer “n” withdraws cryptocurrency to the outside, the processor 110 may deduct the cryptocurrency corresponding to the withdrawal request from the customer's electronic wallet, and remit the corresponding cryptocurrency from the second electronic wallet of the platform to a requested external wallet.

\textcircled{5} The process of \textcircled{5} is the same as \textcircled{3}, and the processor 110 may purchase cryptocurrency required for operation of the platform and remit the cryptocurrency to the electronic wallet of the platform through 1:1 linkage.

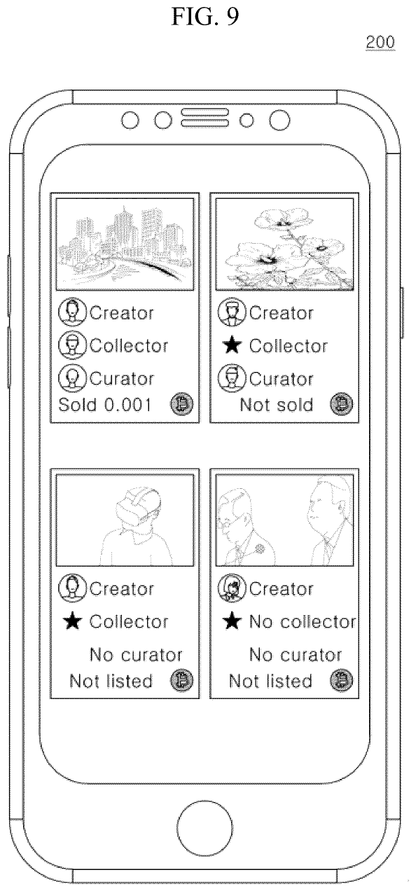

FIG. 9 is a diagram showing an example in which NFT content created by a user is uploaded to the server 100.

Referring to FIG. 9, a first user who has completed order and payment for a product via S500 may upload NFT content to the platform.

When the processor 110 receives the NFT content from the first user terminal 200, the processor 110 may perform NFT minting on the received content and then post the received content on the bulletin board within the platform.

In this case, the bulletin board within the platform may refer to the bulletin board of the server 100, and a separately linked SNS server 100 may be used according to an embodiment.

The NFT content posted on the platform as described above may be purchased by other users using the platform and may be resold.

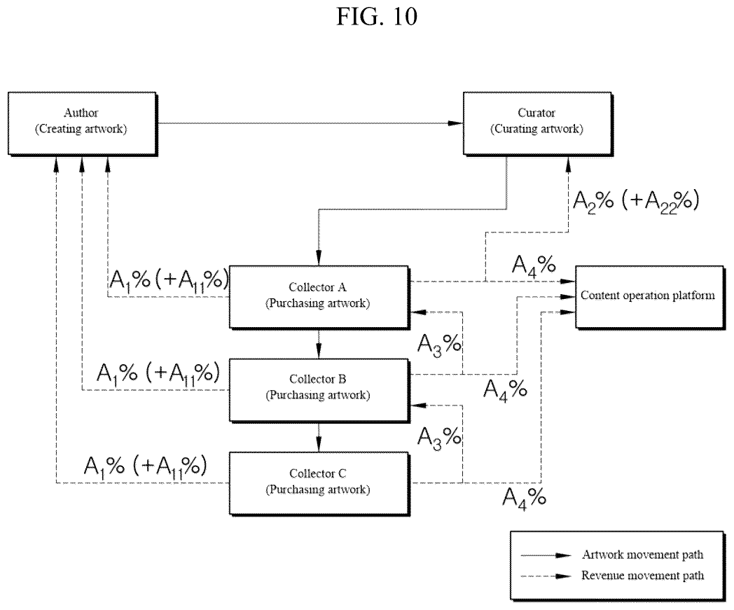

FIG. 10 is a drawing illustrating revenue provided according to the sale of NFT content.

Referring to FIG. 10, in an embodiment of the present disclosure, users may include a first user (Creator) who creates NFT content, a second user (Collector) who resells NFT content created by the first user to other users, and a third user (Curator) who has curator rights to manage, register, and maintain content posted on the platform's bulletin board.

The storage unit stores an algorithm for distributing revenue according to the sale of NFT content. In some embodiments, the storage unit may store a pre-trained artificial intelligence model, wherein the artificial intelligence model is a model learned the algorithm for distributing revenue.

The algorithm for distributing revenue will be described in more detail below.

The processor 110 may calculate revenue allocations for the first user, the second user, and the third user based on the revenue share algorithm when certain NFT content created by the first user is sold via the resale activity of the second user.

The processor 110 may calculate a first influence index based on at least one of the number of views for a post of the certain NFT content and a first indicator for the post of the certain NFT content. The processor 110 may calculate the first user's revenue based on the calculated first influence index.

For example, the processor 110 may calculate the first influence index for the certain NFT content based on a number of views of the post in which the certain NFT content is disclosed.

For example, the processor 110 may calculate the first influence index for the certain NFT content based on the number of user reactions to the post in which the certain NFT content is disclosed.

This means that it is determined that the higher the number of views and reactions from users of the platform and the higher the interest and influence of the NFT content, and the first influence index is calculated. In other words, the higher the number of views and the higher the number of reactions to a post, the higher the first influence Index.

In this case, the number of reactions refers to the number of positive reactions to the post, and indicators such as likes and recommendations may be applied.

In an embodiment, the processor 110 may calculate a revenue (Y) of the first user based on Equation 1 below when the calculated first influence index is less than a predetermined second influence index.

In an embodiment, the processor 110 may calculate the revenue (Y) of the first user based on Equation 2 below when the calculated first influence index is greater than or equal to the predetermined second influence index.

$$Y = ( {A}_{1} \times {X}_{1} ) + ( {A}_{1} \times {X}_{2} ) + ( {A}_{1} \times {X}_{3} ) + … + ( {A}_{1} \times {X}_{n} ) \qquad [ Equation 1 ]$$

$$Y = ( {A}_{1} \times {X}_{1} ) + ( {A}_{1} \times {X}_{2} ) + ( {A}_{1} \times {X}_{3} ) + … + ( {A}_{1} \times {X}_{n} ) + ( {A}_{11} \times {X}_{n} ) \qquad [ Equation 2 ]$$

X: price of the cryptocurrency when the NFT content is sold by the second user
Y: total amount of revenue earned by the first user when NFT content is sold
A₁: percentage of reward received by the first user when NFT content is sold
A₁₁: percentage of additional reward that the first user receives when the first influence index for the NFT content of the first user is greater than or equal to the second influence index when NFT content is sold

In an embodiment, the processor 110 may calculate the revenue (Q) of the third user based on Equation 3 below when the calculated first influence index is less than the predetermined third influence index.

In an embodiment, the processor 110 may calculate the revenue (Q) of the third user based on Equation 4 below when the calculated first influence index is greater than or equal to the predetermined third influence index.

$$Q = {A}_{2} \times {X}_{1} \qquad [ Equation 3 ]$$

$$Q = ( {A}_{2} \times {X}_{1} ) + ( {A}_{22} \times {X}_{n} ) \qquad [ Equation 4 ]$$

A₂: Percentage of rewards received by third party users when selling NFT content
A₂₂: percentage of additional reward that the third user receives when the first influence index for the NFT content of the first user is greater than or equal to the third influence index when NFT content is sold

In an embodiment, the processor 110 may calculate the revenue (Z) of the second user based on Equation 5 below when NFT content is sold by the second user.

$$Z = {A}_{3} \times {X}_{n + 1} \qquad [ Equation 5 ]$$

A₃: Percentage of reward received by the second user when NFT content is sold

In FIG. 10, A₄ may refer to a percentage of the fees received from each of the first user, the second user, and the third user by the platform operated by the server 100.

In an embodiment, when the processor 110 or 310 determines that the first user's terminal 200 has entered a predetermined area or has entered a predetermined distance range from the second store, the processor 110 or 310 may select at least one product matching at least one of the first user's order history, fields of interest, and keywords of interest, among products sold by the second store and perform control such that an image and information of the selected at least one product is displayed on the first user's terminal 200.

The second store may be art museums, exhibition halls, galleries, auction houses, or the like that sell works of art and crafts.

In an embodiment, the processor 110 or 310 may detect and track a first user via the sensor unit 340 when it is determined that the first user terminal 200 has entered a store. Specifically, the processor 110 or 310 may capture the first user via a camera of the sensor unit 340.

In an embodiment, when the first user is captured and tracked as described above, the processors 110 or 310 may identify a location of the first user and a gaze of the first user at preset time intervals and, based on the location and gaze of the first user, display recommended information for the first user via an in-store display device that matches the location and gaze of the first user.

In an embodiment, the processor 110 or 310 may derive the recommended information that match at least one of the first user's order history, fields of interest, and keywords of interest.

In an embodiment, the processor 110 or 310 may determine an artwork that the first user is appreciating based on the location and gaze of the first user, and may provide information about the determined artwork (e.g., artist of the artwork, description of the artwork, and price of the artwork) to the first user's terminal 200. The processor 110 or 310 may add artworks which the first user has appreciated while staying for a preset time period to the first user's favorites list and set the artworks as artworks of interest to the first user, which are to be used to derive recommended information for the first user.

In an embodiment, the processor 110 or 310 may provide the recommended information to the fifth area of the screen of the first user terminal 200. When a certain NFT content corresponding to the recommended information displayed on the fifth screen area of the first user terminal 200 is selected and dragged and dropped into the second area, the processor 110 or 310 may generate order information for the NFT content and control the payment process to be performed.

In the embodiment of the present disclosure, the store can be applied to various locations such as a cafe store, a product store, an artwork store, an artwork exhibition hall, or the like and may also be a form in which stores of various categories are combined. (e.g., café+gallery, etc.).

The system 10 may allow a user to appreciate an artwork online in an offline store, identify information about the artwork online, and make a purchase, payment, and transfer of ownership online. In addition, the system 10 may provide a function to sell/purchase NFT content by providing information in such a way to provide a synchronization function such that the NFT content to be sold is displayed identically on the user's terminal 200 when an NFT sales event is held in an offline store.

In an embodiment, the processors 110 or 310 may provide a fragmented investment feature that allows the NFT content to be split into a plurality of pieces and purchased by multiple users.

In an embodiment, the processors 110 or 310 may calculate a rating for the first user based on the first user's history of visits to the store, purchases made at the store, and may provide benefits such as a discount on purchasing NFT content according to the rating.

In an embodiment, the processor 110 or 310 may calculate a rating for a user based on the number of times the user has created NFT content and the number of times the user has sold NFT content, and may provide benefits based on the rating, such as discounts for purchasing NFT content or discounts for purchasing in-store product.

The method according to an embodiment of the present disclosure described above may be implemented as a program (or application) to be executed in combination with a server, which is hardware, and stored in a medium.

The above-described program may include codes coded in a computer language, such as C, C++, JAVA, or a machine language, which are readable by a processor (CPU) of the computer through a device interface of the computer such that the computer reads the program and executes the methods implemented by the program. The codes may include functional codes associated with a function defining functions necessary to execute the methods or the like, and include control codes associated with an execution procedure necessary for the processor of the computer to execute the functions according to a predetermined procedure. In addition, the codes may further include memory reference codes indicating at which location (address number) of the computer's internal or external memory, additional information or media required for the computer's processor to execute the functions can be referenced. In addition, when the processor of the computer needs to communicate with any other computer or server located remotely to execute the above functions, codes may further include communication-related codes for how to communicate with any other remote computer or server using a communication module of the computer, and what information or media to transmit/receive during communication.

The storage medium refers to a medium that stores data semi-permanently rather than a medium storing data for a very short time, such as a register, a cache, and a memory, and is readable by an apparatus. Specifically, examples of the storage medium may include, but are not limited to, a ROM, a RAM, a CD-ROM, a magnetic tape, a floppy disk, an optical data storage device, and the like. That is, the program may be stored in various recording media on various servers to which the computer can access or various recording media on the computer of a user. The medium may also be distributed to a computer system connected thereto through a network and store computer readable codes in a distributed manner.

The steps of a method or algorithm described in connection with the embodiments of the present disclosure may be implemented directly in hardware, in a software module executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or in a computer readable recording medium that is well known in the art.

Although embodiments of the present disclosure have been described above with reference to the accompanying drawings, it is understood that those skilled in the art to which the present disclosure pertains may implement the present disclosure in other specific forms without changing the technical spirit or essential features thereof. Therefore, it should be understood that the embodiments described above are illustrative in all respects and not restrictive.

According to the embodiments of the present disclosure, it is possible to provide a service for providing a list of products to a user's terminal to allow the user to place an order with the terminal when the entrance of the user to a store is recognized.

Furthermore, according to the embodiments of the present disclosure, it is possible to provide a service for allowing a user to place an order on the user's terminal using conventional fiat currency, credit/debit cards, as well as cryptocurrency.

Furthermore, according to the embodiments of the present disclosure, it is possible to provide a service for allowing a user to create and sell NFT content and providing appropriate rewards to the user who sells NFT content according to an algorithm.

However, effects of the present disclosure may not be limited to the above-described effects. Although not described herein, other effects of the inventive concept can be clearly understood by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A server comprising: a communication unit configured to communicate with a user terminal;
a storage unit configured to store an algorithm for distributing revenue based on sale of NFT content, at least one instruction, and content created by a user;
a processor configured to execute the at least one instruction,
wherein the user includes a first user who creates the content, a second user who resells the content created by the first user to others, and a third user,
wherein the third user is a user with curator rights to manage, register and maintain content posted on a platform's bulletin board, and Non-Fungible Token (NFT) minting is carried out and posted on the bulletin board when the content is sold by the second user,
wherein the processor is configured to
when at least one content created by the first user is received from the first user terminal, allow the third user to perform curation of the received content,
wherein the content posted on the bulletin board is able to be sold to other users using the platform by the second user,
wherein the processor is configured to
when purchase and sale activities for the content are performed, calculate revenue allocations of the first user, the second user, and the third user based on the algorithm for distributing revenue,
calculate a first influence index based on a number of views for a post of specific content and a number of positive responses to the post of the specific content, and
calculate revenues of the first user and the third user based on the calculated first influence index.

2. The server of claim 1, wherein the processor is configured to:
calculate the revenue (Y) for the first user based on Equation 1 below when the calculated first influence index is less than a predetermined second influence index, and
calculate the revenue (Y) of the first user based on Equation 2 below when the calculated first influence index is greater than or equal to the predetermined second influence index.
$$Y = ( {A}_{1} \times {X}_{1} ) + ( {A}_{1} \times {X}_{2} ) + ( {A}_{1} \times {X}_{3} ) + … + ( {A}_{1} \times {X}_{n} ) \qquad [ Equation 1 ]$$
$$Y = ( {A}_{1} \times {X}_{1} ) + ( {A}_{1} \times {X}_{2} ) + ( {A}_{1} \times {X}_{3} ) + … + ( {A}_{1} \times {X}_{n} ) + ( {A}_{11} \times {X}_{n} ) \qquad [ Equation 2 ]$$
X: price of the cryptocurrency when the NFT content is sold
Y: total amount of revenue earned by the first user when the NFT content is sold
A1: percentage of reward received by the first user when the NFT content is sold
A11: percentage of additional reward that the first user receives when the first influence index for the NFT content of the first user is greater than or equal to the second influence index when the NFT content is sold.

3. The server of claim 1, wherein the processor is configured to calculate the revenue (Y) for the third user based on Equation 3 below when the calculated first influence index is less than a predetermined third influence index.
$$Q = {A}_{2} \times {X}_{1} \qquad [ Equation 3 ]$$
A₂: Percentage of reward received by the third user when the NFT content is sold.

4. The server of claim 3, wherein the processor is configured to calculate the revenue (Y) for the third user based on Equation 4 below when the calculated first influence index is greater than or equal to the predetermined third influence index.
$$Q = ( {A}_{2} \times {X}_{1} ) + ( {A}_{22} \times {X}_{n} ) . \qquad [ Equation 4 ]$$
A₂₂: percentage of additional reward that the third user receives when the first influence index for the NFT content of the first user is greater than or equal to the third influence index when the NFT content is sold.

5. The server of claim 1, wherein the processor is configured to calculate the revenue (Z) for the second user based on Equation 5 below when the NFT content is re-sold by the second user who has purchased the NFT content.
$$Z = {A}_{3} \times {X}_{n + 1} . \qquad [ Equation 5 ]$$
A₃: Percentage of reward received by the second user when the NFT content is sold.

6. The server of claim 1, wherein the processor is configured to:
display a list of orderable products on a first area of a screen of the first user terminal,
display a list of payment methods including at least one of cryptocurrency and fiat currency on a second area of the screen of the first user terminal,
generate order information for at least one product in the list according to an input signal input onto the first area of the first user terminal, and
when a payment method for payment of the generated order information is selected on the second area of the first user terminal, perform a payment process through the selected payment method, and display a result of the payment process on a third area of the screen of the first user terminal.

7. The server of claim 6, wherein the processor is configured to:
display the result of the payment process on the third area of the screen of the first user terminal;
display information about a number of people waiting and a waiting time for an order of the first user on a fourth area of the screen of the first user terminal;
add a product selected from the list of products displayed on the first area and dragged to a fifth area to a shopping cart; and
generate the order information based on the product included in the shopping cart on the fifth area.

8. A method performed by a server, comprising:
receiving at least one content created by a first user from a first user terminal;
allowing a third user to perform curation of the received content,
wherein the third user is a user with curator rights to manage, register and maintain content posted on a platform's bulletin board,
wherein Non-Fungible Token (NFT) Minting is carried out and posted on the bulletin board when the content is sold by a second user,
wherein the content posted on the bulletin board is able to be sold to other users using the platform by the second user,
wherein the server is configured to:
when purchase and sale activities for the content are performed, calculate revenue allocations of the first user, the second user, and the third user based on the algorithm for distributing revenue,
calculate a first influence index based on a number of views for a post of specific content and a number of positive responses to the post of the specific content, and
calculate revenues of the first user and the third user based on the calculated first influence index.

9. The method of claim 8, wherein the server is configured to:
calculate the revenue (Y) for the first user based on Equation 1 below when the calculated first influence index is less than a predetermined second influence index; and
calculate the revenue (Y) of the first user based on Equation 2 below when the calculated first influence index is greater than or equal to the predetermined second influence index.
$$Y = ( {A}_{1} \times {X}_{1} ) + ( {A}_{1} \times {X}_{2} ) + ( {A}_{1} \times {X}_{3} ) + … + ( {A}_{1} \times {X}_{n} ) \qquad [ Equation 1 ]$$
$$Y = ( {A}_{1} \times {X}_{1} ) + ( {A}_{1} \times {X}_{2} ) + ( {A}_{1} \times {X}_{3} ) + … + ( {A}_{1} \times {X}_{n} ) + ( {A}_{11} \times {X}_{n} ) \qquad [ Equation 2 ]$$
X: price of the cryptocurrency when the NFT content is sold
Y: total amount of revenue earned by the first user when the NFT content is sold
A1: percentage of reward received by the first user when the NFT content is sold
A11: percentage of additional reward that the first user receives when the first influence index for the NFT content of the first user is greater than or equal to the second influence index when the NFT content is sold.

10. The method of claim 8, wherein the server is configured to calculate the revenue (Y) for the third user based on Equation 3 below when the calculated first influence index is less than a predetermined third influence index.
$$Q = {A}_{2} \times {X}_{1} . \qquad [ Equation 3 ]$$
A2: Percentage of reward received by the third user when the NFT content is sold.

11. The method of claim 10, wherein the server is configured to calculate the revenue (Y) for the third user based on Equation 4 below when the calculated first influence index is greater than or equal to the predetermined third influence index.
$$Q = ( {A}_{2} \times {X}_{1} ) + ( {A}_{22} \times {X}_{n} ) \qquad [ Equation 4 ]$$
A₂₂: percentage of additional reward that the third user receives when the first influence index for the NFT content of the first user is greater than or equal to the third influence index when the NFT content is sold.

12. The method of claim 8, wherein the server is configured to calculate the revenue (Z) for the second user based on Equation 5 below when the NFT content is re-sold by the second user who has purchased the NFT content.
$$Z = {A}_{3} \times {X}_{n + 1} . \qquad [ Equation 5 ]$$
A₃: Percentage of reward received by the second user when the NFT content is sold.

13. The method of claim 8, wherein the server is configured to:
display a list of orderable products on a first area of a screen of the first user terminal,
display a list of payment methods including at least one of cryptocurrency and fiat currency on a second area of the screen of the first user terminal,
generate order information for at least one product in the list according to an input signal input onto the first area of the first user terminal, and
when a payment method for payment of the generated order information is selected on the second area of the first user terminal, perform a payment process through the selected payment method, and display a result of the payment process on a third area of the screen of the first user terminal.

14. The method of claim 13, wherein the server is configured to:
display the result of the payment process on the third area of the screen of the first user terminal,
display information about a number of people waiting and a waiting time for an order of the first user on a fourth area of the screen of the first user terminal,
add a product selected from the list of products displayed on the first area and dragged to a fifth area to a shopping cart, and
generate the order information based on the product included in the shopping cart on the fifth area.

15. A computer-readable recording medium storing a program for executing the method of claim 8 in combination with a computer which is hardware.
